(19) United States
(12) Patent Application Publication
(10) Pub. No.: US 2005/0076053 A1
(43) Pub. Date: Apr. 7, 2005

(54) Method of and apparatus for displaying personal connection information, and computer product

(75) Inventors: Yoshinori Katayama, Kawasaki (JP); Fumihiko Kozakura, Kawasaki (JP); Hiroshi Tsuda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/780,597

(22) Filed: Feb. 19, 2004

(30) Foreign Application Priority Data
Oct. 1, 2003 (JP) 2003-343829

(51) Int. Cl. G06F 7/00

(52) U.S. Cl. 707/102

(57) ABSTRACT

Metadata related to a plurality of persons is extracted from among electronic data that include information about the persons. The metadata extracted is linked based on a co-occurrence of the information about the persons in the electronic data. Relationship between the persons is displayed graphically based on the metadata linked.

### CROSS-REFERENCE TO RELATED APPLICATIONS

This application is based upon and claims the benefit of priority from the prior Japanese Patent Application No. 2003-343829, filed on Oct. 1, 2003, the entire contents of which are incorporated herein by reference.

### BACKGROUND OF THE INVENTION

1) Field of the Invention

The present invention relates to a method of and an apparatus for displaying personal connection information, and a computer product.

2) Description of the Related Art

The field of “knowledge management” (KM) is well known for the gains to be realized from the systematic effort to store and export vast knowledge resources held by employees of an organization. The sharing of knowledge broadly within an organization offers numerous potential benefits to an organization. A systematized and organized common database can be queried from many angles (for instance, as disclosed in Japanese Patent Laid-Open Publication Nos. H10-124491, H 10-283365, 2003-122669, and “Semantic Groupware Workware++ and Application to KnowWho retrieval” by Yoshinori Katayama et. al., IPSJ SIGNotes Fundamental Infology No.071, F1-71-2, May 22, 2003.

However, knowledge or information essentially pertains to people rather than documents. Knowledge management involves much more than extracting relevant documents. Specifically, when a ubiquitous future society envisages multi-faceted dynamic organizations, knowing who has relevant knowledge or skills would be more important or at least knowing who knows someone having relevant knowledge (Know-who based knowledge management) would be more important than being able to extract knowledge from documents.

However, implementation of Know-who based knowledge management presumes a datapool of profiles of the target persons. Manual input of user profile, apart from being a burdensome process, is practically difficult to implement because of various data manipulation related issues arising out of data volume not being sufficiently large enough, obsolescence of information, data not being available due to being irregular or having been entered under an assumed name or simply because of the employee may not have time for contributing towards building the database of profiles. Even if the necessary data is available in the form of a datapool, unless a multi-dimensional rapid search and retrieval process is in place and the search result can be presented in a easy-to-understand manner, the datapool cannot be said to serve any purpose.

### SUMMARY OF THE INVENTION

It is an object of the present invention to solve the problems in the conventional technology.

An apparatus for displaying personal connection information according to one aspect of the present invention includes an extracting unit that extracts metadata related to a plurality of persons from among electronic data that include information about the persons; a linking unit that links the metadata extracted based on a co-occurrence of the information about the persons in the electronic data; and a displaying unit that displays graphically relationship between the persons based on the metadata linked.

A method of displaying personal connection information according to another aspect of the present invention includes extracting metadata related to a plurality of persons from among electronic data that include information about the persons; linking the metadata extracted based on a co-occurrence of the information about the persons in the electronic data; and displaying graphically relationship between the persons based on the metadata linked.

A computer program according to still another aspect of the present invention realizes the method according to the above aspect on a computer.

A computer-readable recording medium according to still another aspect of the present invention stores the computer program according to the above aspect.

The other objects, features, and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a drawing illustrating an example of a hardware structure of a personal connection information display apparatus according to an embodiment of the present invention;

FIG. 2 is a drawing illustrating the functional structure of the personal connection information display apparatus according to the present invention;

FIG. 3 is a drawing explaining schematically the structure of data of metadata of person;

FIG. 4 is a drawing explaining schematically the structure of data of metadata of document;

FIG. 5 is a drawing explaining conceptually the metadata (partial);

FIG. 6 is a drawing explaining an example of a personal connection map;

FIG. 7 is a drawing explaining another example of a personal connection map;

FIG. 8 is a drawing explaining still another example of a personal connection map;

FIG. 9 is a drawing illustrating a prospective venue list; and

FIG. 10 is a flow chart of a process for displaying personal connection information etc. by the personal connection information display device.

### DETAILED DESCRIPTION

Exemplary embodiments of a method of and an apparatus for displaying personal connection information, a computer program for realizing the method on a computer, and a computer-readable recording medium for storing the computer program will be explained next with reference to the accompanying drawings.

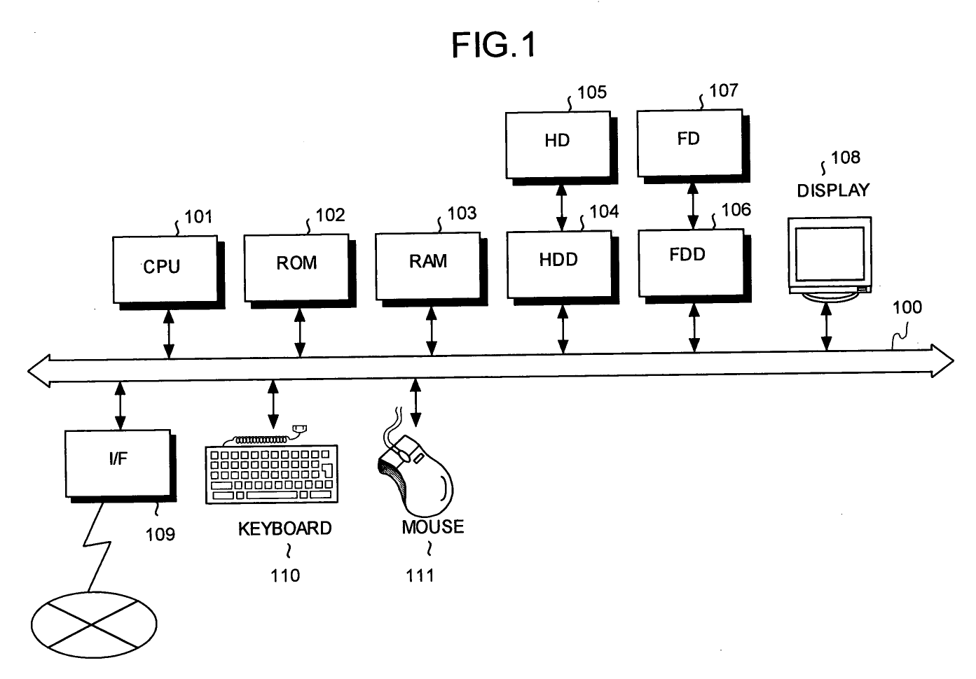

FIG. 1 is a drawing illustrating an example of a hardware structure of a personal connection information display apparatus according to an embodiment of the present invention. The personal connection information display apparatus according to the present invention includes a central processing unit (CPU) 101, a read-only memory (ROM) 102, a random-accesses memory (RAM) 103, a hard disk drive (HDD) 104, a hard disk (HD) 105, a flexible disk drive (FDD) 106, a flexible disk (FD) 107, a display 108, a network interface (network I/F) 109, a keyboard 110, and a mouse 111. A bus 100 connects all the above parts.

The CPU 101 controls the entire apparatus. The ROM 102 stores the booting programs. The RAM 103 is the work area of the CPU 101.

The hard disk drive 104 controls reading data from and writing data to the hard disk 105 in accordance with the control by the CPU 101. The hard disk 105 stores the data written to it in accordance with the control by the CPU 101.

The flexible disk drive 106 controls reading data from and writing data to the flexible disk 107 in accordance with the control by the CPU 101. The flexible disk 107 stores data written to it in accordance with the control by the CPU 101. The flexible disk 107 is an example of a detachable recording medium and can very well be replaced by a CD-ROM (CD-R, CD-RW), MO, digital versatile disk (DVD), memory card, and the like.

The display 108 displays the various cursors, windows, icons, and data such as documents, images, etc. The network interface 109 interfaces with a network such as LAN/WAN and aids in the exchange of data between the network and the apparatus.

The keyboard 110 has keys that facilitate input of characters, numbers, etc. and inputs into the apparatus the data corresponding to the depressed key. The mouse 111 facilitates input into the apparatus in accordance with the amount and direction of rotation of a ball provided underneath, and the clicking of buttons provided on the surface of the mouse.

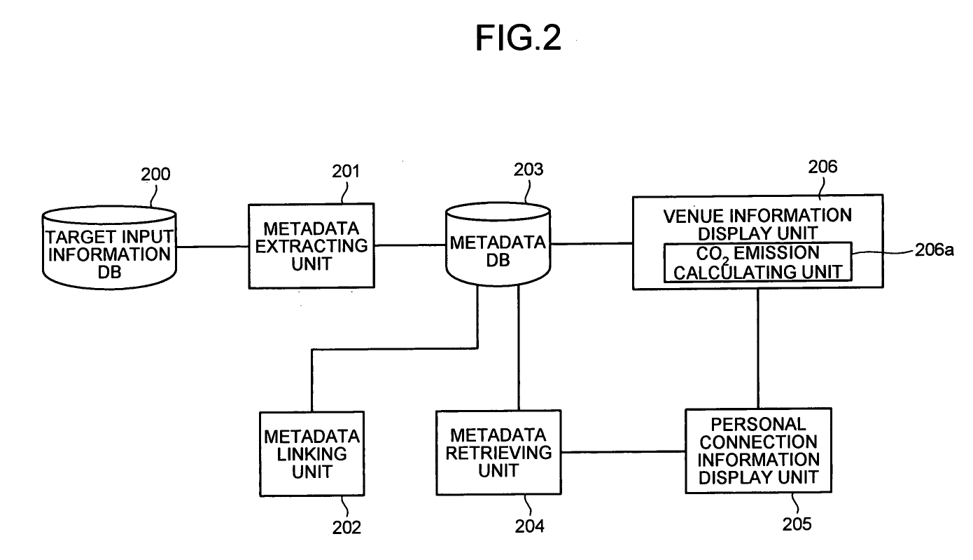

FIG. 2 is a drawing illustrating the functional structure of the personal connection information display apparatus according to the present invention. The personal connection information display apparatus according to the present invention includes a target input information database (DB) 200, a metadata extracting unit 201, a metadata linking unit 202, a metadata DB 203, a metadata retrieving unit 204, a personal connection information display unit 205, and venue information display unit 206. The venue information display unit 206 includes a CO₂ emission calculating unit 206a.

The target input information DB 200 is a database that contains various data (target input information) that form a source from which metadata is extracted. The target input information that is stored in the target input information DB 200 can be all data that include names of a plurality of persons (can be any information that is specific to people). The salient feature of the present invention lies in the fact that the metadata is constructed using, apart from data such as e-mail or schedules in which concerns a plurality of people and in which the relations are well defined, and the names of a plurality of persons, data which have no well defined relation between them.

The target input information can be collected not only from within a member group that is using the apparatus, such as a firm or an organization, but from data that is exchanged between the member group and those outside of the member group. Explained below is the target input information, categorized according to the place of origin.

(1) Target Input Information from within a Group

(1-1) Electronic Data Generated by the Members Themselves

This includes electronic documents (regardless of format) such as minutes of meeting, reports, contracts, and the like, data pertaining to communication between members such as e-mail, BBS, chat, etc, schedules of members entered in a scheduler, or personal information (such as name, affiliation, post, etc.) of members entered in the employee DB.

(1-2) Data Related to Data Access Method of Members

Members who are closely involved are more likely to use, due to professional requirement, the same tools or application (in other words, adopt the same data access method). For instance, if a member belonging to the Business Department A uses a tool that is typically used by a member belonging to the Technical Department B, then the former member is surmised to have some involvement with either Technical Department B or with a member or members of Technical Department B.

(1-3) Data Related to Data Access History (Log) of Members

The keyword input as a search condition often directly reflects the line of work of the user. For instance, if member ‘a’ belonging to Department A and member ‘b’ belonging to Department B mount a search simultaneously on a specific technical term, the two members ‘a’ and ‘b’ are surmised to have some link with one another. Apart from the kind of data that is accessed, the frequency of access also gives a clue about the link between members.

(2) Target Input Information from Outside a Group

These are objective data regarding the group or its member(s) that are created by non-members and include electronic documents such as home pages, newspaper articles, magazine articles, reports, essay, introductory essay, and the like. However, since the quality of such information on the Internet varies vastly, it is important to narrow down the information to only that which is issued by reliable sources or that whose consistent reliability can be ensured by reliable organizations.

(3) Target Input Information that Straddles a Group and those Outside the GROUP

This includes information related to access and communication between the members of a group and the non-members and can, for instance, be e-mail or name card (which is read optically by a scanner or electronically by a RFID tag, etc.) exchanged between a member and a non-member.

The three types of target input information (1) to (3) described above are either stored in a file server shared by the member or a personal file server. As long as a network connection is in place, data can be collected from either server. However, collecting data from the personal file server would require prior consent of the member concerned, taking into consideration the time of accessing the data and the privacy factor.

The metadata extracting unit 201 extracts metadata related to a person, document, schedule, etc. from all types of target input information stored in the target input information DB 200. The metadata linking unit 202 links with one another the metadata extracted by the metadata extracting unit 201 and creates or sorts a secondary metadata obtained as a result of linking the metadata. The metadata DB 203 stores metadata obtained by the process described above.

The documents created by the members themselves directly indicate the relevant member's professional content or skill. Consequently, the metadata related to the documents created by the members are correlated with the metadata of the members and stored in the metadata DB 203. The metadata of a document would be, specifically speaking, the title of the document, author, date of creation, date of updation (modification history), place where used (relevant meeting or persons), keywords from the document, etc.

If names of a plurality of persons appear in a document (whether of members or non-members), irrespective of their affiliations, it is surmised that there is some link between these members/non-members. Consequently, the data of these members/non-members are also correlated and stored in the metadata DB 203.

The closer the names appearing in the same document (for instance, in a single phrase or a single paragraph), the stronger the link between them is considered to be, and vice versa. Consequently, the strength of the link between any given number of names is calculated on the basis of their place of appearance in the document. More specifically, the names entered in the field “Attended by” in a conference record are considered to have a strong link. Further, if a name A and a name B appearing in a document conform to a certain pattern such as ‘<name A>and <name B>’, then again, the link between name A and name B is considered strong.

Conversely, the names even if they appear in related documents (such as a group of documents unified by the same viewpoint) are considered to have a strong link between them. In such a case, the related documents may be clustered together to form a single document, and the names appearing in this clustered document may be correlated. While clustering related documents, predetermined algorithm such as linking by clustering or common keyword, or clustering rule can be used.

For the names that are weakly linked in accordance with the target input information type (1-1) described above but are suggested to have a strong link in accordance with the target input information type (1-2) or (1-3), the actual strength of link is calculated by adding the strength of link suggested by (1-2) or (1-3) to the strength of link suggested by (1-2). A more accurate and exhaustive link can be established by additionally using the information provided by the target input information type (2) and (3) in addition to the target input information type (1) (that is, the member-created data).

Particularly in the target input information type (2) which pertains to data procured from the Internet, apart from narrowing down data from reliable sources only, a cleaning technology (technology for removing the ‘garbage data’) needs to be employed for extracted names, extraction method, etc. For instance, information on the Internet is not necessarily standardized. Hence, there is a requirement for using a predefined dictionary database or a rule base.

The metadata can be in any format. However, the conventional RDB (relational database) is unsuitable for storing ever-changing and multi-faceted information such as that pertaining to relationship between persons. The present invention uses Resource Description Framework (RDF) of Semantic Web as the format for storing metadata.

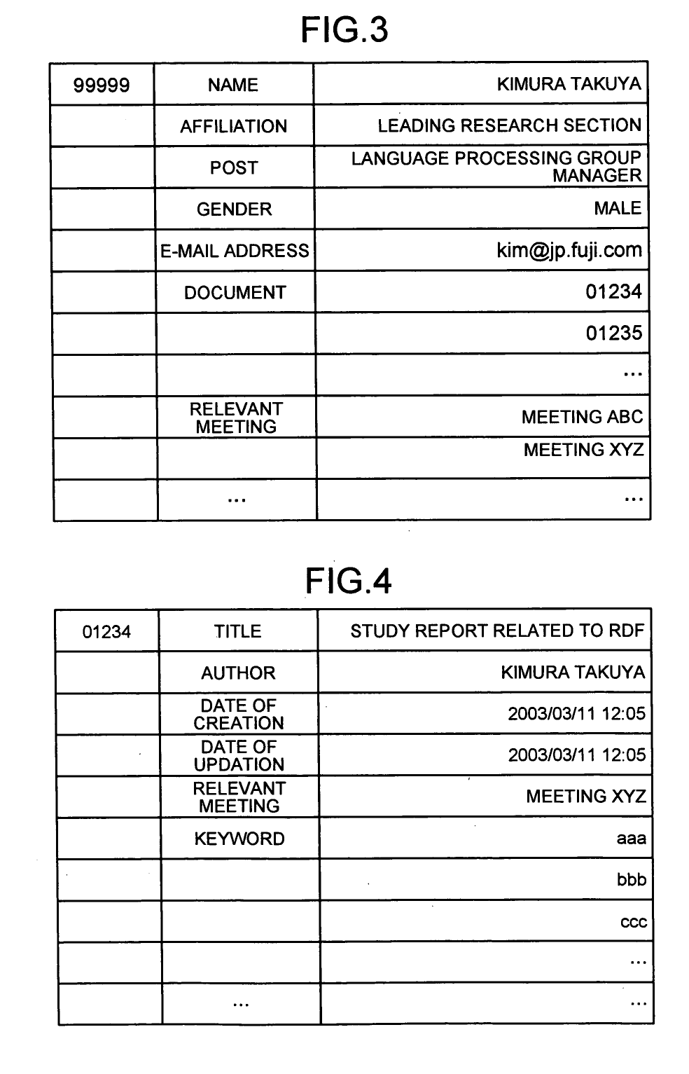

FIG. 3 and FIG. 4 are drawings explaining schematically structures of data of metadata stored in the metadata DB 203. FIG. 3 is an example of a metadata of a person. FIG. 4 is an example of a metadata of a document. Both the metadata are made of a set of an ID, an identifier, and a value. In FIG. 3, for instance ‘99999’ is the ID, ‘Name’, ‘Affiliation’, etc. are the identifiers, and ‘Kimura Takuya’, ‘Leading Research Section’, etc. are the values.

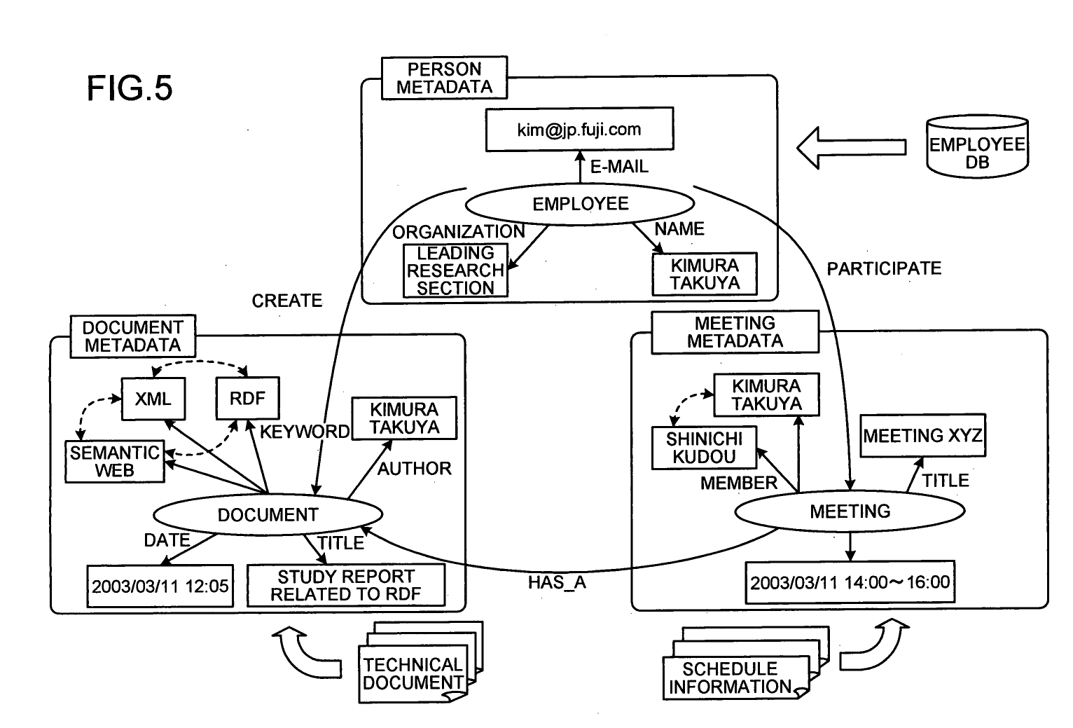

FIG. 5 is a drawing explaining conceptually the metadata (partial) stored in the metadata DB 203. The metadata ‘Employee’, ‘Document’, and ‘Meeting’ extracted from the target input information are defined in detail and the relationship between them are established. The links represented by dashed lines are established by mining by metadata linking unit 202. These links mainly represent co-occurring relationship, for instance, the relationship between keywords frequently appearing in a single document, or the relationship between persons frequently attending the same meeting, etc.

The metadata retrieving unit 204 retrieves data to be displayed on the personal connection information display unit 205 from among the metadata stored in the metadata DB 203. In other words, the metadata retrieving unit retrieves only the metadata to be displayed.

Since metadata DB 203 has a staggering amount of metadata all of which possibly cannot be displayed at the same time, the metadata retrieving unit 204 lets the user select a condition for the metadata retrieval. The metadata retrieving unit 204 then retrieves from the metadata DB 203 the metadata satisfying the user-specified condition and sends the retrieved metadata to the personal connection information display unit 205.

For instance, upon specifying a keyword typical to a technology or topic, the metadata retrieving unit 204 retrieves, from among the metadata in the metadata DB 203, only the metadata of the member/non-members who are linked with the technology or topic. The relationship of each person is displayed in the form of a personal connection map explained later. By varying the condition for retrieval of metadata, personal connection can be viewed in various different dimensions from a single metadata DB 203.

The conditions for retrieval can be number of link (personal connection) paths, number of persons, affiliation or group, profile information of person, keyword, strength of link, etc, singly or combinations thereof.

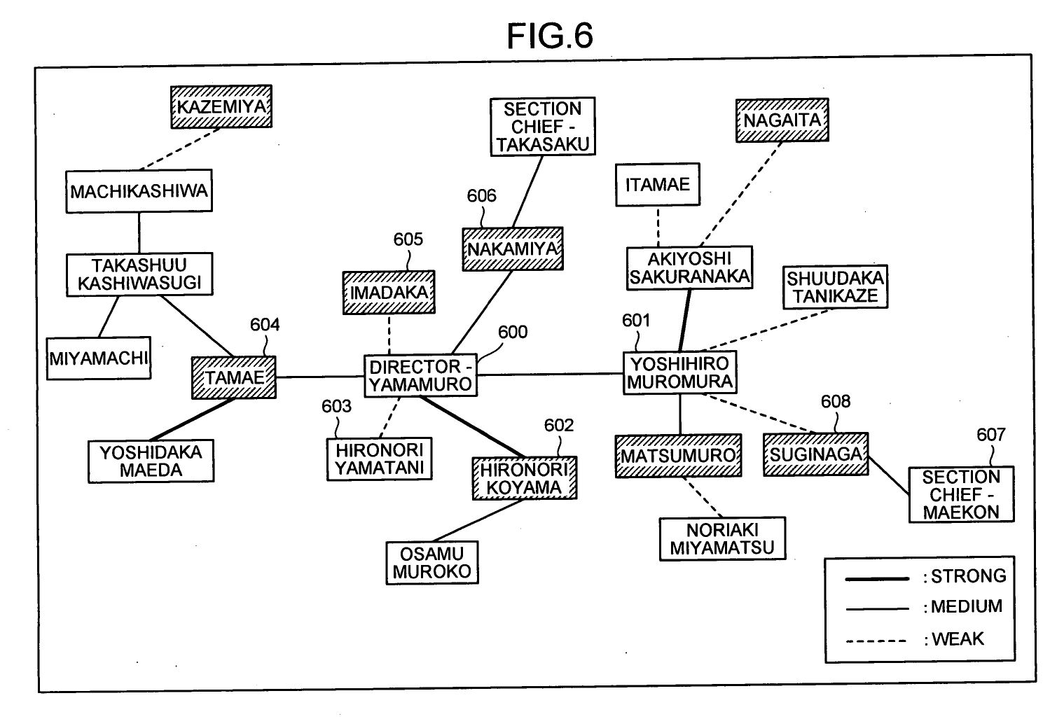

The personal connection information display unit 205 displays viscerally in the form of a map the metadata received from the metadata retrieving unit 204. FIG. 6 is a drawing explaining an example of a personal connection map displayed by the personal connection information display unit 205. As long as the metadata DB 203 contains the metadata as shown in FIG. 5, the personal connection information display unit 205 can display the relationship between a certain person and a document related to the person. However, FIG. 6 shows a personal connection map representing a relationship exclusively between persons.

The personal connection map has a tree structure. In other words, the root ‘Director Yamamuro’ 600 has six child items, namely ‘Yoshihiro Muromura’ 601, ‘Hironori Koyama’ 602, ‘Hironori Yamatani’ 603, ‘Tamae’ 604, ‘Imadaka’ 605, and ‘Nakamiya’ 606. Each of these child items in turn may have one or a plurality of child items. The entire tree is structured in a one-to-many relationship with many child items per parent and each child item having only one parent.

The metadata pertaining to persons generally has a many-to-many relationship, If all the metadata found by the metadata retrieving unit 204 were to be displayed, the metadata will be displayed in the form of a network rather than a tree. However, displaying all of the data will result in a complicated personal connection map. Therefore, the present invention eliminates relatively weak personal connections and presents an uncluttered personal connection map.

In the metadata extracted from the metadata DB 203, ‘Section Chief—Maekon’ 607 placed at the lower right is related in some way with ‘Suginaga’ 608 and ‘Hironori Koyama’ 602 located in the lower center. If the link between ‘Section Chief—Maekon’ 607 and ‘Hironori Koyama’ is considered to be the weakest among the circle of links comprising ‘Section Chief—Maekon’ 607—‘Director—Yamamuro’ 600—‘Yoshihiro Muromura’ 601—‘Suginaga’ 608—‘Section Chief—Maekon’ 607, the relation between the two, namely ‘Section Chief—Maekon’ 607 and ‘Hironori Koyama’, is not shown, as illustrated in FIG. 6. If the weakest link is considered to be between ‘Yoshihiro Muromura’ 601 and ‘Suginaga’ 608, the circle gets cut off with ‘Yoshihiro Muromura’ 601, and ‘Section Chief—Maekon’ 607 is placed under ‘Hironori Koyama’ 602 and ‘Suginaga’ 608 is placed under ‘Section Chief—Maekon’ 607.

The lines linking the names in the personal connection map illustrated in FIG. 6 shows the degree of strength of the link between the names linked by the line. The personal connection map in FIG. 6 shows a single tree. It is also possible to have a plurality of tree in a personal connection map by virtue of names not having any link between them (or having so weak a link that no link is shown between them and hence the names become entities belonging to different trees).

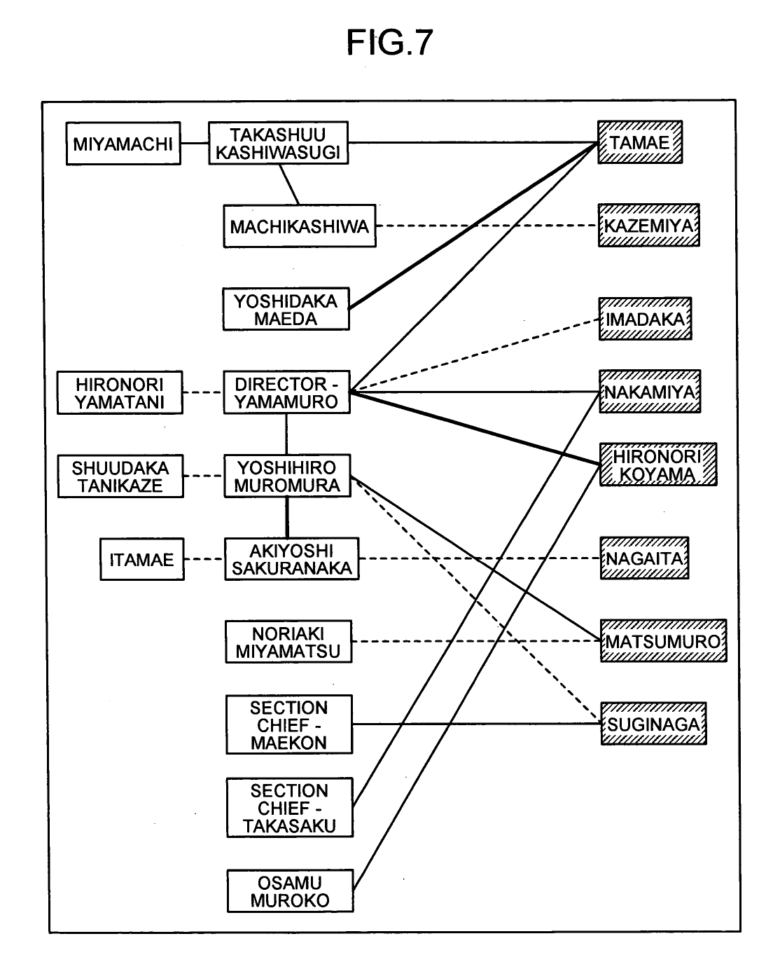

The pattern of the icon (shaded or non-shaded) within the personal connection map indicates the affiliation of an individual. The affiliation, post, etc. of individuals can be differentiated by using icons of different colors or shapes. The members and non-members can also be differentiated by simply having different display positions for each group, as shown in FIG. 7 in which the icons of members are displayed on the left of the screen and those of non-members are displayed on the right. Particularly, for appreciating the strength of personal connection between groups, differentiating the groups by displaying them at different positions as shown in FIG. 7 is more helpful than representing the icons by different colors or shapes.

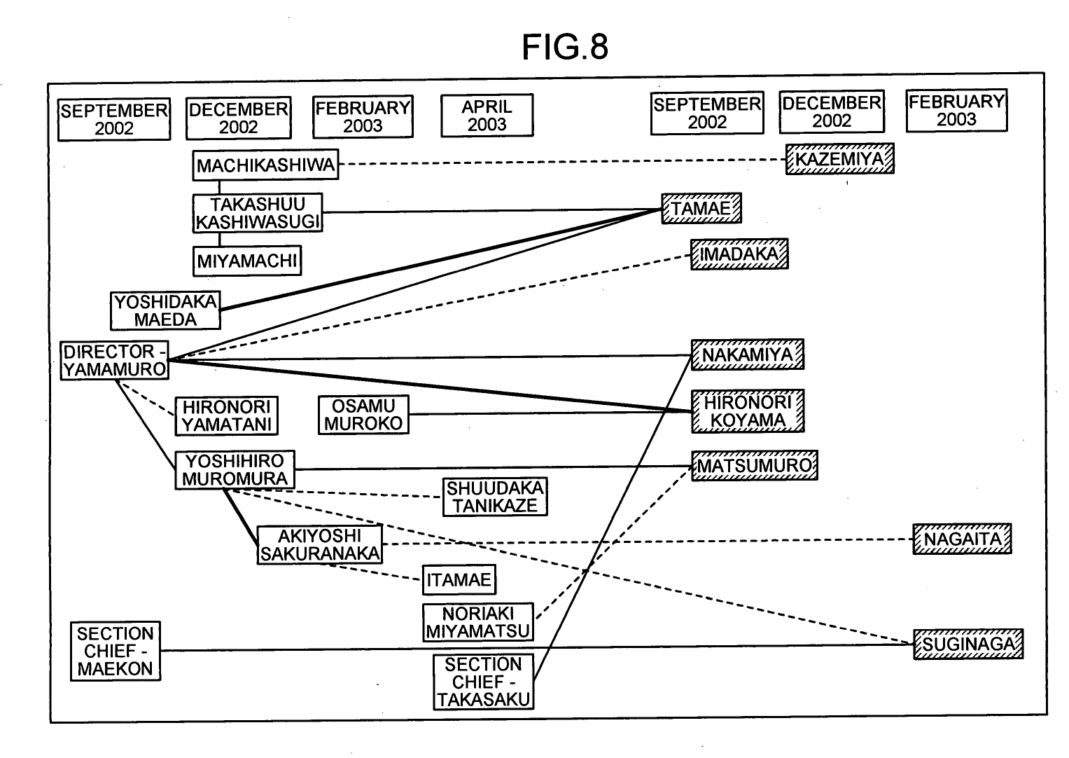

It is not possible to learn from FIG. 6 and FIG. 7 how far back the connection or link between two individuals goes. Hence, as a variation of FIG. 7, the personal connection map may be represented with a time-line included in the map as shown in FIG. 8. For instance, the relative merits of ‘Section Chief—Maekon’ and ‘Section Chief—Takasaku’ cannot be discerned by referring to FIG. 7 alone where the strength of the link is represented by the thickness of the line. However, by referring to FIG. 8 where a time-line is provided, one can appreciate the fact that ‘Section Chief—Maekon’ appears in the personal connection map over six months before ‘Section Chief—Takasaku’ and hence it can be surmised that ‘Section Chief—Maekon’ leads ‘Section Chief—Takasaku’ in experience and, a not-evident-from-the-drawing personal connections.

The venue information display unit 206 picks out and presents to the user a convenient and effective venue where plurality of specified individuals can assemble.

One of the objectives of the user for using the group share link map is to assemble the right human resource from across the organization in order to commission a project. Thus selecting a venue for the members to assemble is the next important task. Whereas the functional units such as the target input information DB 200, the metadata extracting unit 201, the metadata linking unit 203, metadata retrieving unit 204, and the personal connection information display unit 205 take part exclusively in processes leading up to the display of personal connection information, the venue information display unit 206 refers to the displayed personal connection and aids the work that has a high probability of being carried out next by the user.

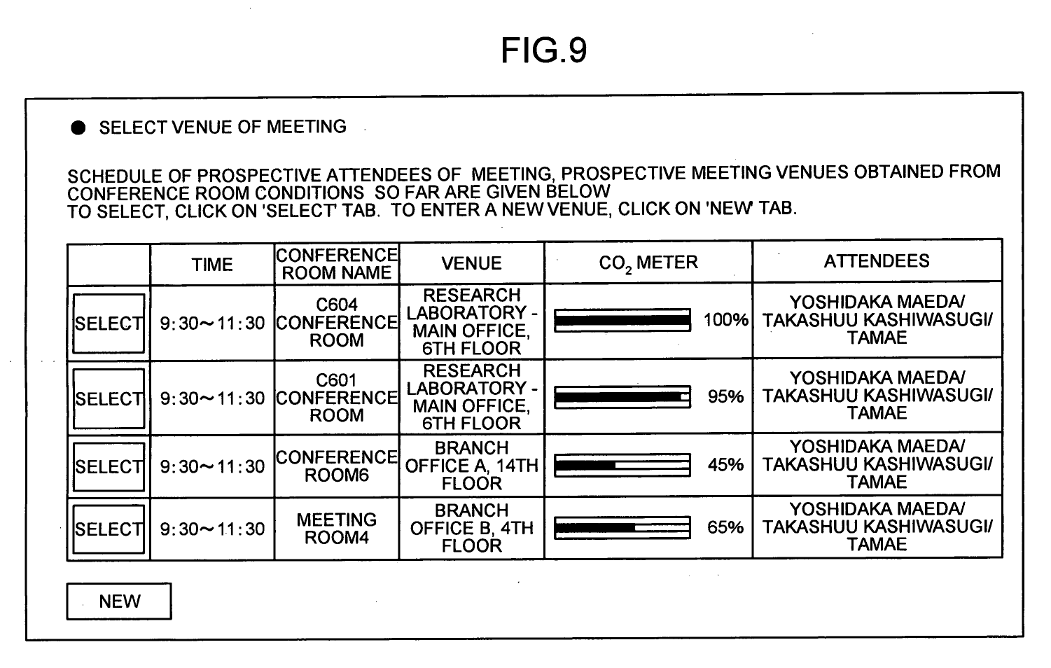

As shown in FIG. 5, the metadata DB 203 contains links between individuals and schedules. The schedules are stored along with their venues. Thus, a frequently used conference room can be identified from the metadata. When names are selected from the personal connection map, the venue information display unit 206 ranks by a given rule the venues strongly associated with the individuals and displays them in the form of a prospective venue list as shown in FIG. 9.

In FIG. 9, the column titled ‘CO₂ meter’ represents the relative total amount of CO₂ emitted at each venue due to the assembly of the members. In other words, ‘C604 conference room’ is considered as having a maximum CO₂ emission of 100%, and the CO₂ emission of the each venue of assembly is calculated as a ratio with respect to the maximum CO₂ emission. The CO₂ emission can also be represented by an absolute numeric value.

The CO₂ emission is calculated by the CO₂ emission calculating unit 206a provided inside the venue information display unit 206. The CO₂ emission calculating unit 206a calculates the CO₂ emission from the distance of shift and stores in the form of a table of standard CO₂ emission when shifting the business hub between two points. For example, the CO₂ emission calculating unit 206a may calculate a CO₂ emission of 12 between head office and branch office A, 50 between branch office A and branch office B, and so on, and store these calculated values in a table. The CO₂ emission of each individual is determined from the starting point, which again can be determined from the affiliation of the individual, and the destination which can be any of the venues from the prospective venue list. The CO₂ emission calculating unit 206a then totals up the CO₂ emission for all the members expected to attend the meeting and presents the total CO₂ emission for each prospective venue if it were to be made the actual venue of assembly.

In the present invention, CO₂ was taken as the index for measuring the effect on the environment. However, energy consumption may also be taken as an index for measuring the effect on the environment and a venue that imparts least damage to the environment may be a criterion for selecting a venue for the meeting.

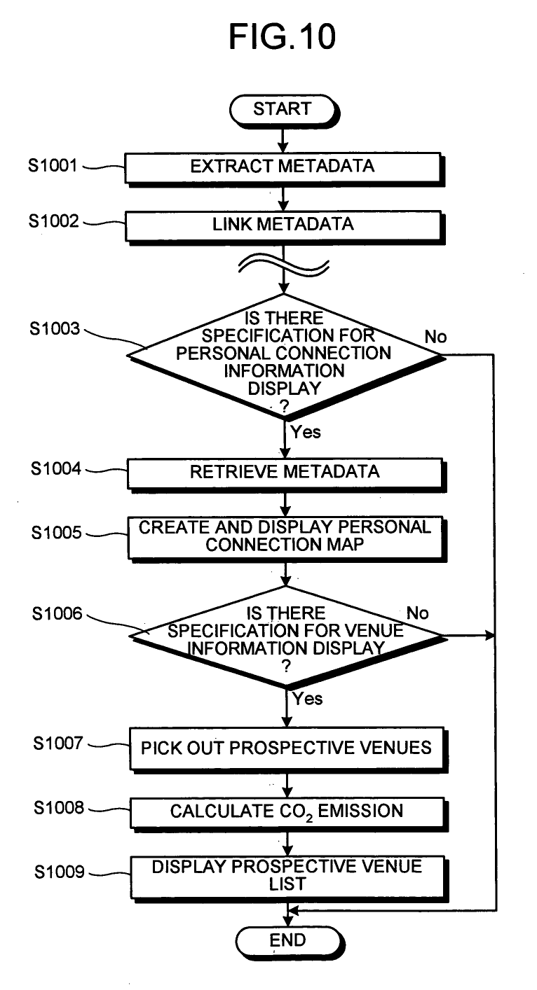

FIG. 10 is a flow chart for explaining the sequence of steps for displaying personal connection information etc. by the personal connection information display device according to the present invention.

When target input information is entered in a pre-specified or periodically specified server, the metadata extracting unit 201 of the personal connection information display device stores the target input information in the target input information DB 200 and starts extracting the metadata from the target input information (step S1001). The metadata linking unit 202 further links the extracted metadata (step S1002) and stores the linked metadata in the metadata DB 203.

Next, it is determined if the user has specified a condition for retrieval data and their display in the personal connection data map (step S1003). If there is no specification by the user (‘No’ at step S1003), the process ends here. If there is a specification (‘Yes’ at step S1003), the metadata retrieving unit 204 retrieves from the metadata DB 203 the metadata that satisfy the specified condition (step S1004). The personal connection information display unit 205 creates and displays the personal connection map as shown in FIG. 6 using the retrieved metadata (step S1005).

Next, it is determined if the user has specified a plurality of names and requested the display of venue of assembly (step S1006). If there is a specification for the display of venue of assembly (‘Yes’ at step S1006), the venue information display unit 206 picks out the prospective venues from the metadata in the metadata DB 203 (step S1007). The CO₂ emission calculating unit 206a calculates the total CO₂ emission for each prospective venue if it were to be made the actual venue of assembly (step S1008), and displays the venue list as shown in FIG. 9 (step S1009). If there is no specification for the display of venue of assembly (‘No’ at step S1006), the process ends with the display of personal connection map.

Thus, personal connections related to a project which has participation across an entire organization can be widely and multi-dimensionally displayed, with the latest electronic data as the basis. As a result, it is possible to get an accurate picture of subgroups within groups or links between subgroups (in the form of intermediary persons, etc.) and thereby be able to predict whose exclusion can potentially hinder a given task. Furthermore, the above function can be realized without performing any burdensome tasks such as collecting data, entering profiles, etc.

The personal connection map was useful as a means of assembling members for a new project and for picking out a suitable venue of meeting for the members. Apart from this, it is also possible to predict the completion date of a given project from the schedules of the members involved and the time required for the completion of each task of the project, and present a suitable date of completion of the project in the preliminary meeting.

The personal connection information display method according to the present embodiment can be realized by running a computer program on a workstation or a personal computer. This computer program may be stored in any computer-readable recording medium such as a hard disk, flexible disk, CD-ROM, MO, DVD, etc. and is executed by the computer by reading from the recording medium. This computer program may also be stored in a transmission medium such as the Internet which can be distributed via a network.

The method, the apparatus, and the computer program according to the present invention allow the user to find out, in realtime and at any required time, who has the required knowledge and who has connection or link with the person who has the required knowledge from automatically collected latest data. Moreover, the method, the apparatus, and the computer program according to the present invention further allow the user to find out a suitable venue where the required human resource can assemble.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A method of displaying personal connection information, comprising:
extracting metadata related to a plurality of persons from among electronic data that include information about the persons;
linking the metadata extracted based on a co-occurrence of the information about the persons in the electronic data; and
displaying graphically relationship between the persons based on the metadata linked.

2. The method according to claim 1, wherein the electronic data is an electronic document on the Internet.

3. The method according to claim 1, wherein the linking includes linking the metadata based on a structure of the electronic data from which the metadata is extracted.

4. The method according to claim 1, wherein the linking includes linking the metadata based on the co-occurrence of the information about the persons in a combined electronic data which is obtained by combining a plurality of electronic data.

5. The method according to claim 1, further comprising retrieving, from among the metadata linked in the metadata linking process, the metadata that satisfy a filter condition, wherein
the displaying includes displaying graphically the relationship between the persons based on the metadata retrieved.

6. The method according to claim 1, further comprising displaying a suitable venue for assembly of the persons whose relationship has been displayed.

7. A computer program for realizing displaying of personal connection information, the computer program making a computer execute:
extracting metadata related to a plurality of persons from among electronic data that include information about the persons;
linking the metadata extracted based on a co-occurrence of the information about the persons in the electronic data; and
displaying graphically relationship between the persons based on the metadata linked.

8. The computer program according to claim 7, wherein the electronic data is an electronic document on the Internet.

9. The computer program according to claim 7, wherein the linking includes linking the metadata based on a structure of the electronic data from which the metadata is extracted.

10. The computer program according to claim 7, wherein the linking includes linking the metadata based on the co-occurrence of the information about the persons in a combined electronic data which is obtained by combining a plurality of electronic data.

11. The computer program according to claim 7, further making the computer execute retrieving, from among the metadata linked in the metadata linking process, the metadata that satisfy a filter condition, wherein
the displaying includes displaying graphically the relationship between the persons based on the metadata retrieved.

12. The computer program according to claim 7, further making the computer execute displaying a suitable venue for assembly of the persons whose relationship has been displayed.

13. A computer-readable recording medium that stores a computer program for realizing displaying of personal connection information, the computer program making a computer execute:
extracting metadata related to a plurality of persons from among electronic data that include information about the persons;
linking the metadata extracted based on a co-occurrence of the information about the persons in the electronic data; and
displaying graphically relationship between the persons based on the metadata linked.

14. An apparatus for displaying personal connection information, comprising:
an extracting unit that extracts metadata related to a plurality of persons from among electronic data that include information about the persons;
a linking unit that links the metadata extracted based on a co-occurrence of the information about the persons in the electronic data; and
a displaying unit that displays graphically relationship between the persons based on the metadata linked.

15. The apparatus according to claim 14, wherein the electronic data is an electronic document on the Internet.

16. The apparatus according to claim 14, wherein the linking unit links the metadata based on a structure of the electronic data from which the metadata is extracted.

17. The apparatus according to claim 14, wherein the linking unit links the metadata based on the co-occurrence of the information about the persons in a combined electronic data which is obtained by combining a plurality of electronic data.

18. The apparatus according to claim 14, further comprising a retrieving unit that retrieves, from among the metadata linked in the metadata linking process, the metadata that satisfy a filter condition, wherein
the displaying unit displays graphically the relationship between the persons based on the metadata retrieved.

19. The apparatus according to claim 14, wherein the displaying unit displays a suitable venue for assembly of the persons whose relationship has been displayed.
